(19) United States
(12) Patent Application Publication
(10) Pub. No.: US 2005/0007397 A1
(43) Pub. Date: Jan. 13, 2005

(54) Method of changing display resolution

(75) Inventors: Masahiko Hatori, Ebina-shi (JP); Yasumi Hida, Kawasaki-shi (JP); Takenobu Nakao, Tokyo-to (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/917,649

(22) Filed: Aug. 13, 2004

Related U.S. Application Data
(62) Division of application No. 10/244,863, filed on Sep. 17, 2002.

(30) Foreign Application Priority Data
Sep. 18, 2001 (JP) 2001-282895

(51) Int. Cl. G09G 5/02; G09G 5/00

(52) U.S. Cl. 345/698

(57) ABSTRACT

When a user performs a specified operation, a resolution changing unit 22 changes display resolution of a display device 10, allowing the size of texts and images, which are displayed inside of a window, to be increased or decreased at a touch. In order not to maintain the position and size of a window in the display area before and after changing display resolution, an unchanged information acquisition unit 21 acquires the position and size of the window before changing resolution, and then a window display changing unit 23 performs window display processing using the acquired information. In addition, the resolution of texts and images displayed inside of a window is changed with change of display resolution.

### RELATED APPLICATIONS

This application is a divisional application taking priority under 35 USC 121 from co-pending application Ser. No. 10/244,863 filed 17 Sep. 2002 and assigned to common ownership with the present application.

### FIELD OF THE INVENTION

The present invention relates to a display device.

### BACKGROUND OF THE INVENTION

Display devices remain a primary means for presenting computer systems output to users. The resolution of display devices have continued to increase enabling more information to be presented on the display device.

However, the screen size (or display area) of a display device is limited by physical size of the display device itself. For example, a panel display, which is installed on a notebook computer, is limited to the size of the main body due to the shape of a notebook computer. In addition, the screen size of a display device for a desktop computer is also limited because the display device is placed on a desk. Especially, a CRT (Cathode Ray Tube) display can not be continually increased in its size due to its footprint installation area and the weight of the display.

Therefore, the higher resolution for screens of a limited physical size has been achieved by decreasing dot pitch, which is a minimum unit of display. Recently, improvements in LCD (Liquid Crystal Display) panel and CRT technologies have resulted in a considerably increase in display resolution. This enables a display device to display an entire large sized (having a great number of dots) image within the display area, or a plurality of objects on the screen at the same time.

As described above, higher resolution screens with smaller dot pitch allows a display device to display a much larger amount of information than lower resolution displays. However, the physical (display area) size of images and texts is also reduced with smaller dot pitch, so that the legibility or readability of the information is decreased.

Objects, such as text, icons, and application windows, are displayed on a desktop according to the operating system (hereinafter referred to as OS, i.e., Microsoft Corporation's Windows (R) 95, Windows (R) 98, and Windows (R) NT) of a computer.

Conventionally, the desktop resolution of the screen (or display area) of a display device can be set at many different levels. Therefore, a user can select a desktop resolution and to change the size of objects displayed on the desktop.

However, reducing the desktop resolution in order to display an object in a larger scale can result in the entire object no longer being displayed on the screen or multiple objects can not be displayed at the same time. Moreover, when the desktop resolution is changed the OS automatically rearranges icons and application windows on the desktop at the selected desktop resolution. As a result, the arrangement of icons and application windows are changed, which makes using the computer more difficult and may be annoying to the user. In addition, some OS may initiate a reboot to the display or display driver in changing the desktop resolution at least on the OS side, which interrupts the user's use of the display and as a result the computer. Therefore, simply changing the desktop resolution may not fully address the need to have more information presented on the screen or display area.

### SUMMARY OF THE INVENTION

To solve above-described problems, in a computer system according to the present invention the display resolution of a display unit is changed by a resolution changing unit when the system receives a user's operation and then an event generator generates a specified event, without essentially changing the physical size of an object displayed in the display unit. The objects include windows, such as application windows, and other items, such as icons and task bars, displayed on the screen or display area of a display device.

In an alternative embodiment the position of objects is maintained before and after changing the display resolution.

In another embodiment, when the object is an application window the display resolution in an internal area of the application window is changed. Thus, the display size of texts and images displayed in the internal area (within the application window) are changed based on change of the display resolution, while maintaining the size of the application window on the screen or display area.

A display device according to the present-invention comprises a display controller to change the display resolution of the display device is response to a specified event, while essentially maintaining the position and size of an application window on the screen or display area of the display device.

More particularly, the display controller stores information concerning the position and size of an application window as displayed on the screen or display area of the display device using the display resolution which has not changed yet. This information may be stored in information storage. After the display resolution is changed, the display controller displays the application window based on the stored information in the information storage. As a result, the position and size of the application window can be maintained before and after changing the display resolution.

Moreover, in another alternative embodiment the information storage stores information concerning the overlapping relationship of a plurality of application windows displayed in the display device before changing the display resolution. After a resolution change, the application windows are displayed in the same overlapping relationship as before the resolution change.

A display controller of a display device according to the present invention receives an event generated by an event generator in response to a specified operation from the outside, and then acquires information concerning the position and size of an application window displayed on the screen of the display device by an information acquisition unit. Subsequently, the display controller makes the application window to be displayed on the screen by a display processing unit in the same position and size as that before changing display resolution, the display resolution of which is changed by a resolution changing unit, based on the information concerning position and size acquired by the information acquisition unit.

Furthermore, the display controller also acquires information concerning the size of an operating object displayed on a peripheral part of an application window, such as a tool bar, scroll bar, and tool button, and then make the object to be displayed in the same size as that before changing display resolution based on the acquired information.

In addition, the display controller also acquires information concerning the position and size of an object besides an application window, such as an icon and task bar, and then makes the object to be displayed in the same position and size as that before changing the display resolution based on the acquired information.

According to the present invention, a coordinate, which defines the size of an object such as a window displayed on a screen at a first display resolution, is acquired, then the display resolution of the display device is changed from a first to a second display resolution, and the acquired coordinates are interpolated correspondingly. It is preferable that interpolation is performed in such a manner that an object is displayed at the second resolution in the same size as that displayed at the first resolution. The object uses the same amount of screen area or display area for both the first resolution and the second resolution. Furthermore, a coordinate, which defines the position of an object at the second resolution, may be acquired, and then interpolation is performed to display an object at the same position as that displayed at the first display resolution after changing to the second display resolution. Subsequently, the objects are displayed on the screen of the display device, the display resolution of which is changed to the second resolution, based on the interpolated coordinate. Here, the object is displayed based on the interpolated coordinate, whereas contents to be displayed in the inside area of the above-described object are displayed without interpolation corresponding to the change from the first to second display resolution. Thus, the inside objects are displayed at the second display resolution without interpolating or without scaling so that the inside objects are not using the same portion of the display area in the two different resolutions. Thus, more information, although smaller, will be displayed within the window when going from low to high resolution. Correspondingly less information, although larger, will be displayed within the window when going from high to low resolution.

Alternatively, at the step of interpolating the coordinate, interpolation may be performed so that the object is displayed in the same size or position as that after changing the display resolution.

In an image processing method according to the present invention, a change resolution request is received from a user, and then information concerning the object displayed is acquired. Subsequently, the object is displayed in the same size as that before changing display resolution on a display device, the display resolution of which is changed, based on the acquired information.

In addition, if the object is an application window, contents to be displayed in the application window, such as texts and images, may also be displayed at the changed display resolution.

A computer program according to the present invention causes a computer system to execute a process comprising the steps of: detecting a specified request command received from the outside; detecting the size of an object displayed in the display area of a display device; changing a display resolution of the display device according to a request command; and displaying the object in a size, detected before changing the display resolution in a display device, the display resolution of which is changed.

### ADVANTAGES OF THE INVENTION

As described above, according to this invention, switching between normal and enlarged displays can be performed by simple operations providing both more information at a high display resolution and legibility of display contents.

### OBJECT OF THE INVENTION

It is therefore an object of the present invention to switch between normal resolution mode and a high resolution mode with simple operations to attain both a large amount of information due to high resolution while maintaining the legibility, readability, and usability of displayed objects.

To provide both a large amount of information at high display resolution and legibility for display contents.

### BRIEF DESCRIPTION OF THE DRAWINGS

Other features of the present invention will be more readily understood from the following detailed description of specific embodiments thereof when read in conjunction with the accompanying drawings, in which:

FIG. 1 illustrates a configuration of PC in an embodiment according to this invention;

FIG. 2 illustrates a process flow when changing display resolution;

FIG. 3 illustrates an exemplary display in changing display resolution between plural levels;

FIG. 4 illustrates an exemplary screen at low resolution before and after changing display resolution; and

FIG. 5 illustrates an exemplary screen at high resolution before and after changing display resolution.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numbers signify like elements throughout the description of the figures.

Now the present invention will be described in detail in accordance with a preferred embodiment as shown in the accompanying drawings. Hereinafter PC and a PC display device are employed as an example of a computer system and a display or output device respectively.

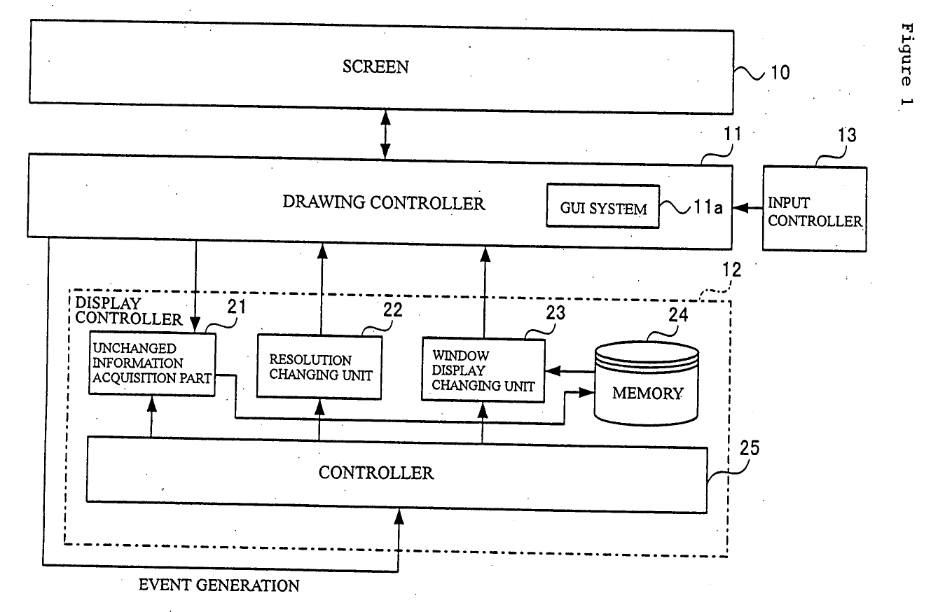

FIG. 1 illustrates schematically a configuration of the preferred embodiment for a PC. In FIG. 1, a display device 10 is a LCD panel or a CRT-type display device (a display device or the main body of a display device), and a drawing controller 11 controls drawing of the display device 10. A display controller 12 controls display changes of icons or windows on the screen when changing display resolution of the display device 10. In addition, an input controller 13 receives inputs in response to a user's operation through a keyboard, mouse or other input devices.

The drawing controller 11 comprises a GUI system 1 la, which controls drawing of icons or windows displayed in GUI (Graphical User Interface) on the screen (display area) of the display device 10.

The GUI system 11a displays the icons of applications or files, or application windows in an area (size) according to a default value or definition set by a user on the screen. Furthermore, when a user performs a specified operation, such as click, double click, or drag, the GUI system 11a directs execution of actions including activation or termination of applications, and opening and closing of files.

In an application window displayed on the screen of the display device 10 under drawing control of the GUI system 11a, texts and images are to be displayed based on file data or data which is opened or accessed by the application.

The display controller 12 maintains the display position and size of application windows (hereinafter they are simply referred to as the position and size of windows) before and after changing display resolution of the display device 10. In the preferred embodiment the display controller 12 is implemented with a CPU, video chips, main memory, or video memory, and programs to control those resources, and performs the above-described processing with software.

The display controller 12 comprises an unchanged information acquisition unit (coordinate acquisition unit) 21, a resolution changing unit 22, and a window display changing unit (window display controller, display unit, or window display unit) 23. The unchanged information acquisition unit 21 acquires the position and size of windows before changing display resolution, and the resolution changing unit 22 changes display resolution of the display device 10. The window display changing unit 23 changes the position and size of windows when changing display resolution. The display controller 12 also includes memory (information storage) 24 to store specified data during processing. Furthermore, the display controller 12 includes a controller 25, which controls the unchanged information acquisition unit 21, the resolution changing unit 22, and the window display changing unit 23, in order to perform the above-described functions according to events transmitted from OS.

The resolution changing unit 22 changes display resolution of the display device 10 based on a request which may be transmitted from the input controller 13, which receives an event generated by a user's input (i.e, from a keyboard, mouse or operation of another input device), via the drawing controller 11. Display resolution of the display device 10 can be set at six levels of 2048×1536 dots (QXGA), 1600×1200 dots (UXGA), 1280×1024 dots (SXGA), 1024×768 dots (XGA), 800×600 dots (SVGA), and 640×480 dots (VGA). When a user selects a desired display resolution from a plurality selectable levels, the resolution changing unit 22 changes display resolution of the display device 10. With this method, basically, higher display resolution of the display device 10 increases the amount of information which may be displayed on the screen, while decreasing the display size of texts and images. On the other hand, lower display resolution increases the display size of texts and images.

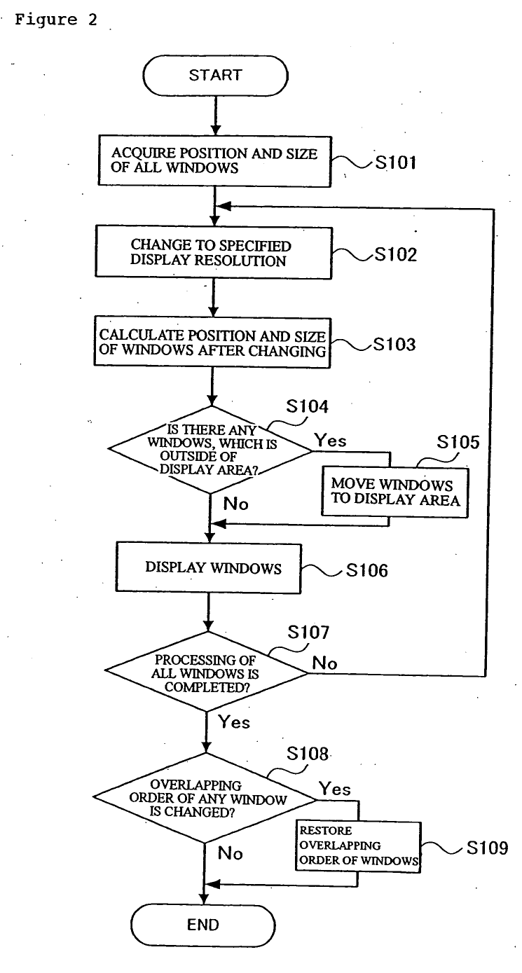

Referring now to FIG. 2, the process flow of changing display resolution of the display device 10 in the above-described PC will be described. When a user wants to change display resolution of the display device 10, the display resolution of which, for example, is 1024×768 dots (XGA: a first resolution), the user performs a predetermined operation through a keyboard or other input device. Here, the user specifies a desired display resolution (i.e., 2048×1536 dots (QXGA: a second resolution)).

Subsequently, the input controller 13 requires the display controller 12 to change display resolution of the display device 10 through the drawing controller 11 in response to the users operation or request.

In the display controller 12, before the resolution changing unit 22 changes display resolution to a specified one, the unchanged information acquisition unit 21 acquires the position and size of all the windows displayed on the screen of the display device 10 (Step S101).

At this point, APIs (Application Program Interface)
GetWindowPlacement ( ), and
GetWindowRect ( )
   are issued to the unchanged information acquisition unit 21.

In addition, when a plurality of windows are displayed on the screen some may be overlapping, the unchanged information acquisition unit 21 also acquires the overlapping relationship (or overlapping order) of these windows.

The acquired information comprising the position and size of windows, and overlapping relationship is temporarily stored in the memory 24.

Subsequently, the resolution changing unit 22 changes display resolution of the display device 10 to the specified resolution (Step S102).

On the other hand, the window display changing unit 23 calculates (or interpolates) the position and size of windows to be displayed on the screen after changing display resolution through a coordinate interpolator (Step S103). The window display changing unit 23 executes the following calculations based on the information temporarily stored in the memory 24, comprising the position and size of unchanged windows, and the ratio of display resolutions before and after changing.

For example, when the size of a window before changing display resolution is
(Lx, Ly)=(600, 400)
and the position (upper left coordinate) of the window is
(X, Y)=(300, 200),
display resolution is changed from 1024×768 dots (XGA) to 2048×1536 dots (QXGA). In this case, the size of the window after changing display resolution is
Lx′=600*2048/1024=1200
Ly′=400*1536/768=800,
thus
(Lx′, Ly′)=(1200, 800)

Also, the position of the window after changing display resolution is
X′=3002048/1024=600
Y′=2001536/768=400,
thus
(X′, Y′)=(600, 400)

When display resolution is reduced (i.e., resolution is changed from 2048×1536 dots (QXGA) to 1024×768 dots (XGA)), the position and size of an unchanged window may cause the changed window to be outside of the screen of the display device 10.

To avoid this problem, it is determined whether the window, the position and size of which are calculated at Step S103, is outside of the screen (the coordinate area of the screen is known) of the display device 10 (Step S104). If the window is outside of the screen, the window is moved inside of the screen of the display device 10 (Step S105).

With the above-described method, the position and size of the window, which is displayed on the screen of the display device 10 before changing display resolution, are changed, and then the window is displayed on the screen of the display device 10 (Step S106).

At this point, APIs
SetWindowPos( ) and
SetWindowRect( ),
   are issued to the unchanged information acquisition unit 21.

Subsequently, it is determined whether the position and size of all the windows displayed on the screen before changing display resolution are changed. If not, the process is returned to Step S102 and then continued (Step S107).

If the position and size of all the windows are changed and plural windows are displayed on the screen of the display device 10, the overlapping relationship is compared with that of the unchanged windows, which is stored in the memory 24. Furthermore, it is determined whether the overlapping order of any window is changed with the change of display resolution (Step S108). If the overlapping order of any window is changed it is restored to the overlapping order of unchanged windows (Step S109).

In this way, a user performs display resolution changing operations, and windows (objects) W are displayed on the screen of the display device 10 in the physically same position and size as that before changing display resolution. In the inside area of the window (inside area) A, texts and images, which are displayed before changing display resolution, are displayed at the changed display resolution.

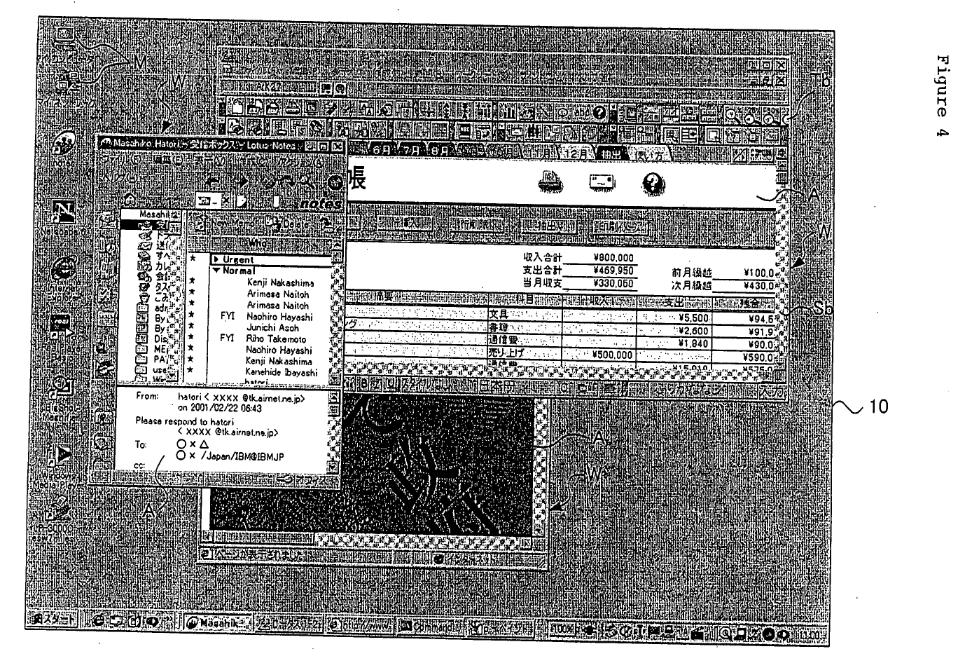

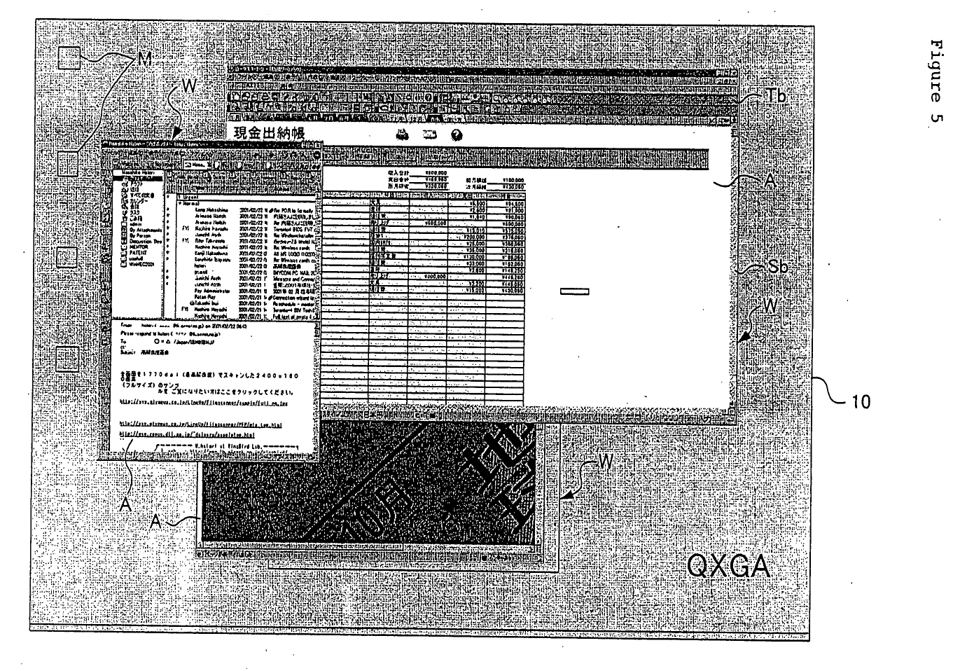

FIGS. 4 and 5 illustrate exemplary display before and after changing display resolution when display resolution is changed with the above-described method. FIGS. 4 and 5 show exemplary display at low and high display resolutions respectively.

When increasing display resolution (i.e., change from 1024×768 dots (XGA) to 2048×1536 dots (QXGA)), the display conditions as shown in FIG. 4 are switched to those as shown in FIG. 5. As a result, the amount of information, such as texts and images, displayed in a window W increases, while maintaining the position and size of each window W.

On the other hand, when reducing display resolution (i.e., change from 2048×1536 dots (QXGA) to 1024×768 dots (XGA)), display conditions as shown in FIG. 5 are switched to those as shown in FIG. 4. As a result, texts and images displayed in a window W are enlarged, while maintaining the position and size of each window W.

When performing the above-described display resolution change, the position and size of a window W is maintained before and after changing. As for a tool bar (operating object) Tb, a scroll bar (operating object) Sb, and buttons and fonts of an operating menu displayed on the tool bar Tb, their physical size may be unchanged before and after changing display resolution, or may be changed corresponding to the change of display resolution. If unchanged, the size of only texts and images displayed inside of a window A is decreased or increased, so that smooth switching can be achieved. If the physical size of the tool bar Tb or other objects is changed, the display of the objects may be enlarged to improve legibility (in case of decreasing display resolution) corresponding to changing, or may be decreased to enlarge the display area except for the operating objects (in case of increasing display resolution).

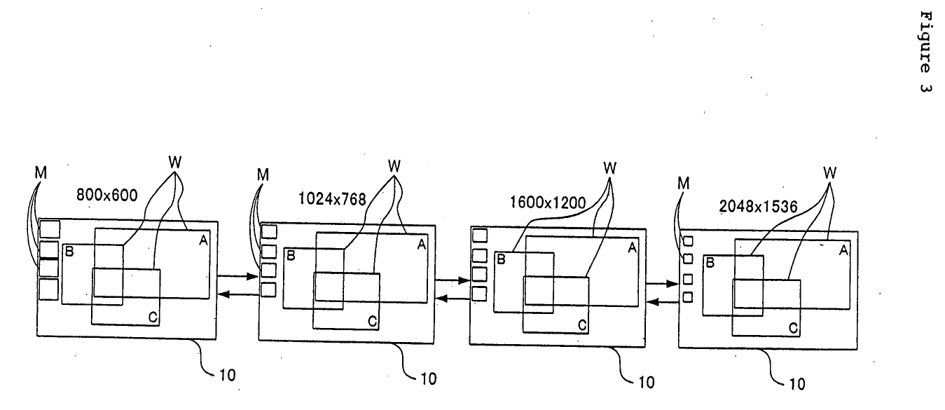

In addition, as for other objects displayed on the screen, such as icons, task bars, task trays, and title bars, their physical size may be unchanged before and after changing display resolution, or may be changed corresponding to the change of display resolution (In FIG. 3, the size of an icon (object) M is to be changed corresponding to the change of display resolution).

As described above, the size of texts and images, which are displayed inside of a window A, can be increased or decreased at a touch by a user's predetermined operation. This enables a user to enlarge displayed objects to increase legibility or to decrease the size of displayed objects to increase the amount of information displayed in a window W according to situations. Furthermore, a user can perform the switching at a touch. When changing display resolution of the display device 10, the display controller 12 performs the control process so that the position and size of a window W are not changed, providing a seamless operating environment to a user. In addition, the size of texts and images is increased or decreased with the change of display resolution, so that there is no input limitation as in conventional scaling tools, providing a user-friendly scaling tool.

Currently, in the display device 10, the XGA mode of 1024×768 dots is often employed as standard, and each object is generally generated considering this mode. However, if the display device 10 can display objects in the QXGA mode of 2048×1536 dots, the amount of information to be displayed is increased. In this case, if objects, which are to be displayed in the XGA mode, are displayed without any processing, they are displayed in a very small size, decreasing legibility. In such a case, even if the display device 10 can display objects in the QXGA mode of 2048×1536 dots, objects are normally displayed in the XGA mode of 1024×768 dots. If a user wants to display more information, he/she can switch to the QXGA mode of 2048×1536 dots at a touch, enabling the display device 10 to be effectively employed.

Preferably, if a user switches to the QXGA mode of 2048×1536 dots, the physical size of icons, task bars, task trays, title bars and other items, and texts that are displayed with the items is not changed so as not to decrease legibility before and after changing display resolution.

In the embodiments mentioned above, PC is employed as an example of devices having the above-described functions. In addition to PC, mobile telephone terminals, PDA (Personal Digital Assistants), car navigation systems may also be employed. Furthermore, similar configuration can be applied to game devices, which employ a television as a display device, and display controllers that have display control functions, such as set-top boxes.

A program, which controls the display of objects when changing display resolution, can be used and stored in the storage medium and program transmission system.

In the case of a storage medium, the program, which makes a computer system to execute the above-described functions, is stored in CD, DVD, memory, or a hard disc so that the computer system can read it.

In the case of a program transmission system, it includes a storage device to store the above-described program, such as CD, DVD, memory, or a hard disc, and a transmission device to transmit the program to a device, which executes the programs, via connector or a network such as the Internet or LAN. Such a program transmission system is suitable to install the program, which has the above-described functions, to PC.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

1. A display resolution change method to change a display resolution of a
display device, comprising the steps of:
storing a coordinate, which defines the size of a window displayed in the display device at a first display resolution;
changing the display resolution from said first display resolution to a second display resolution;
interpolating the stored coordinate in response to said change from the first to the second display resolution; and
displaying the window according to the interpolated coordinate and a display content to be displayed in an inside area of the window without interpolation corresponding to said change from the first to the second display resolution.

2. The display resolution change method as described in claim 1, wherein at the step of interpolating the coordinate, a coordinate is interpolated so that the size of the window displayed at the first display resolution is equivalent to that at the second display resolution.

3. The display resolution change method as described in claim 1, wherein at the step of interpolating the coordinate, a coordinate is interpolated so that the position of the window displayed at the first display resolution is equivalent to that at the second display resolution.
